(19) United States
(12) Patent Application Publication
(10) Pub. No.: US 2004/0086612 A1
(43) Pub. Date: May 6, 2004

(54) Frozen confection

(75) Inventors: Willem Antheunisse, Vlaardingen (NL); Mark John Berry, Bedford (GB); Yvonne Evelien Bruggeman, Vlaardingen (NL); Robert Daniel Keenan, Bedford (GB); Elisabeth Comelia Bouwens, Vlaardingen (NL)

Correspondence Address: UNILEVER, PATENT DEPARTMENT, 45 RIVER ROAD, EDGEWATER, NJ, 07020, US

(73) Assignee: Good Humor-Breyers Ice Cream, Division of Conopco, Inc.

(21) Appl. No.: 10/643,243

(22) Filed: Aug. 18, 2003

(30) Foreign Application Priority Data
Aug. 19, 2002 (EP) 02255761.5

(51) Int. Cl. A23B 4/03

(52) U.S. Cl. 426/465

(57) ABSTRACT

The invention relates to a method to prepare a frozen aerated confection wherein pectin is subjected to oxidation. In a further aspect the invention relates to a base composition suitable for preparing the frozen confection and to an aerosol can comprising the base composition.

### FIELD OF THE INVENTION

The invention relates to a method for the preparation of a frozen aerated confection using a ferulyoated polymer.

### BACKGROUND TO THE INVENTION

Powdered products and instant mixes for the preparation of ice cream are well known. One of the advantages of the use of these compounds is that they can be stored and shipped without the need for refrigeration during storage and shipping. These compositions can be re-constituted with water to form an ice cream composition. An example of a process to prepare a powdered ice cream product is disclosed in U.S. Pat. No. 5,370,893.

However there are several disadvantages to these mixes in preparing the final ice cream. Firstly the reconstitution with water to obtain good texture and stable foam requires the use of a conventional ice cream maker which is a disadvantage when such products are used by a consumer for making their individual ice cream. Furthermore the reconstituted products according to the prior art are not always stable i.e. they collapse during storage. There is a need for the provision of a simple base composition from which an aerated frozen confection can be prepared in a convenient manner.

It is an object of the invention to provide a method and base composition suitable to overcome one or more of these disadvantages of the prior art compositions.

U.S. Pat. No. 2002/0028197 discloses “self-gelling” powders and solutions containing a ferulyoted polymer and an enzymic oxidation system in an essentially inactivated state. For powdered materials it also states that the powders preferably contain a dispersant (e.g. glucose or maltodextrin). Such powders are formulated to be self-gelling but not necessarily foamable while gelling. It also states that such materials find application as a foodstuff, dietary fibre, food ingredient, additive, lubricant, supplement or food dressing. Such products include ice cream.

U.S. Pat. No. 4,672,034 discloses that oxidised pectins can be used to prepare milk-based and iced desserts but no compositions are given for self-gelling powders or liquids containing protein at more than 1%.

U.S. Pat. No. 6,232,101 discloses that oxidase-promoted gelling of phenolic polymers can find application in foodstuffs such as ice cream. No compositions containing protein, suitable for preparing base compositions are disclosed.

None of the aforementioned references discloses cross-linking of a polymer during the making of an ice cream product.

### SUMMARY OF THE INVENTION

We have surprisingly found that a method wherein the aerated frozen confection is prepared from a base composition with ferulyolated polymer wherein in the base composition an inactivated enzyme composition is present which can be activated at a later stage of the process to form crosslinked polymers stabilising the frozen aerated confection, fulfils this objective.

Therefore the invention relates to a method for the preparation of an aerated frozen confection which comprises the steps of:—

a) a base composition comprising a ferulyolated polymer and an essentially inactivated enzymatic oxidation system is packed into a container under conditions wherein the enzymatic oxidation system remains essentially inactivated;

b) at least a portion of the base composition is combined with a substance that activates the enzymatic oxidation system;

c) aeration; and

d) the base composition and/or the composition resulting from step (b) or step (c) is subjected to freezing conditions;

wherein aeration is simultaneous with activation of the oxidation system in step (b).

The primary advantage of the present invention is delivered by virtue of cross-linking of the polymer (due to activation of the oxidation) being simultaneous with (ie having some temporal overlap with) aeration.

The invention further relates to a base composition suitable for use in this method and the aerated frozen composition obtainable by this process.

### DETAILED DESCRIPTION OF THE INVENTION

In the context of the invention aerated is defined as containing a gas, preferably a dispersed gas. This gas may be oxygen or air but suitable alternatives include nitrogen, helium, argon, nitrous oxide, carbon dioxide or a combination of any of these.

The aerated frozen confection according to the invention is preferably characterised by an overrun (defined as ((volume of ice cream-volume of premix either at ambient temperature or at 5° C.) divided by the volume of premix at ambient temperature) times 100%.) of from 50 to 300%, at atmospheric pressure.

In the context of the invention viscous is defined as a viscosity in the range of 1 to 100,000 mPa s at a shear rate of 100 s⁻¹ and a temperature of 5° C., preferably 10 to 1000 mPa s under these conditions.

The invention is based on the presence of essentially inactivated enzymatic oxidation system in a base composition. This base composition comprises a ferulyolated polymer. Such polymers containing ferulic acid groups attached to their backbone are known to be susceptible to oxidation. An example of these polymers is pectin from certain plants, e.g. sugar beet. The oxidation may be achieved by addition of an appropriate amount of an enzyme of the oxidase type e.g. laccase or peroxidase. The oxidation reaction leads to the formation of ferulic acid-ferulic acid covalent bonds (di-ferulic acid residues) and this enables the formation of a crosslinked polymer.

“Essentially inactivated” enzymatic oxidation system means that under the conditions used in the base composition, less than 5 number % or alternatively, 3×10⁻⁶ mol of ferulic acid residues per gram of polymer of ferulic acid residues on the polymer are converted to di-ferulic acid residues after storage for 1 week at ambient temperature.

In step (b) at least a part of the base composition is combined with a substance that activates the oxidation system.

“Activated oxidation enzyme system” is defined as follows: more than 15 number % of ferulic acid residues on the polymer are converted to di-ferulic acid residues within 15 minutes. Preferably the activation is such that the oxidation system facilitates oxidation of 30 to 90 number %, more preferred 40 to 80 number % ferulic acid residues within 15 minutes. Even more preferred this level of oxidation is obtained within from 1 to 10 minutes after activation of the oxidation system, most preferred within from 1 to 5 minutes.

The amount of di-ferulic acid groups formed can be determined by measuring the decrease of ferulic acid by the HPLC method described in the examples.

In step (a) of the method according to the invention, a base composition comprising a ferulyolated polymer and an essentially inactivated enzymatic oxidation system is packed into a container under conditions wherein the enzymatic oxidation system remains essentially inactivated.

Such conditions for example include the absence of oxygen, the absence of water, the absence of a substance essential to the activation of the oxidising system such as hydrogen peroxide or persulfate, the absence of a required cofactor or enhancer, control of pH or temperature such that the oxidation system is essentially inactivated.

Excess oxygen or hydrogen peroxide may be scavenged by inclusion of any of ascorbic acid, and organic and inorganic (eg an alkali metal such as sodium) salts thereof, and mixtures thereof.

The container as used in step (a) may be a small size can or tub such as a manually operated aerosol can. Such containers are preferably 10 to 1000 ml in size for individual use. Alternatively the base composition is stored in amounts suitable for use on factory scale. In such cases an individual container may be 1 kg to 1000 kg in size.

In step (b) at least a portion of the base composition is combined with a substance that activates the enzymatic oxidation system.

A variety of enzymes are capable of oxidising the ferulic acid groups such that diferulic groups are formed. Enzymes that are suitable for catalysing this reaction are generally part of two different groups. The first group comprises oxygenases such as laccase, the second group comprises peroxidases such as horseradish peroxidase. The first group is dependent on oxygen for catalysing oxidation reactions. The second group is dependent on hydrogen peroxide for catalysing oxidation reactions. Hence the oxygenases are in inactivated state as long as the conditions are essentially oxygen free. The peroxidases are essentially inactive as long as conditions are essentially hydrogen peroxide free. Both groups of enzymes are most active if water is present and hence an essentially water free environment is generally sufficient to keep the enzymes in essentially inactivated state.

Optionally the formation of hydrogen peroxide is mediated by an oxygenase such as glucose oxygenase.

The substance activating the oxidation system is preferably water or oxygen. This activation leads to an oxidation of ferulic acid residues forming di-ferulic acid.

The activation of the oxidation system may take place at any suitable temperature provided that the subsequent oxidation takes place at sufficient speed. Suitable temperatures are between minus (−) 40° C. and 60° C. Preferably the temperature is from −10° C. to 40° C.

At some stage in the method according to the invention, the frozen confection is aerated. This aeration is carried out according to general methods known in the art of preparing frozen confections. Whipping of the composition or dispersion of a gas via a gas line are examples of suitable methods. The gas applied is preferably selected from the group comprising oxygen, air, nitrous oxide and carbon dioxide.

Preferably aeration is simultaneous with activation of the oxidation system in step (b).

In the method according to the invention the base composition and/or the composition resulting from step (b) or step (c) is subjected to freezing conditions. It is preferred that the base composition is not subjected to freezing conditions but is kept at room temperature. Most preferred the freezing takes place after aeration.

Preferably before or after freezing the product is packed into individual containers.

Suitable freezing conditions are temperatures of from − (minus) 5 to − (minus) 80° C., more preferred− (minus) 10 to − (minus) 30° C.

The final product may be consumed directly after it's preparation or may be stored at a preferred temperature of from − (minus) 10 to − (minus) 40° C.

Regarding the order of steps of the method according to the invention there are several preferred routes.

According to one embodiment oxidation by activation of the oxidation system, aeration and freezing are carried out simultaneously.

According to another embodiment oxidation is followed by aeration and freezing, provided that there is at least some temporal overlap in aeration and the cross-linking process.

According to another embodiment aeration and oxidation take place after freezing. It will be appreciated that this embodiment is preferred if oxidation is by an enzyme that shows sufficient activity at sub-zero temperatures.

Optionally the method according to the invention includes one or more steps in which other ingredients are added. Examples of such ingredients are fat, emulsifier, sweetener, colouring agent, flavouring agent, fruit paste, fruit concentrate, protein, stabiliser, herbs, chocolate pieces, cookie pieces, a pre-prepared ice phase.

In case the base composition is a powder, the addition of an aqueous liquid is required before or during step (b) to ensure the enzymatic oxidation system functions and the end product is similar to a general aerated frozen confection.

In general it is recommended that compositions with more than 15% water should be kept under anaerobic conditions before step (b) to ensure that the oxidation system, remains inactivated.

The method according to the invention may be carried out as one sequence of events on one location, e.g. in a factory or other production facility. It is however preferred that step (a) takes place at one location whereafter the container is transported to a remote location before step (b) takes place.

According to one embodiment the container is of a size suitable to hold an amount of base composition suitable to prepare from 1 to 10, preferably 1 to 5 end products, whereby an end product is of the size of one average serving for an individual consumer. In this embodiment, the container is transported to a location where the product is distributed to buyers (e.g. a supermarket). Subsequently the buyer or another third person may carry out step (b) of the method.

Preferably the container is disposable.

Even more preferred the container has a size of one serving and in step (b) the entire contents of the container are combined with a substance that activates the enzymatic oxidation system.

In a further aspect the invention relates to a base composition for a frozen aerated confection, characterised in that the composition comprises a ferulyolated polymer and an essentially inactivated enzymatic oxidation system.

The compound comprising ferulyolated groups is a polymer, more preferred a polysaccharide. Generally suitable polymers have a weight average molecular weight of over 3,000 g per mol and preferably over 10,000 g per mol. Examples of suitable polymers include pectin, arabinan, galactan, cellulose derivatives, galactomannans such as guar gum, locust bean gum, starches or other polymers comprising hydroxyl groups which can be esterified to a ferulic acid group.

The polymers comprising ferulic acid groups can be naturally occurring or synthesised polymers. Examples of naturally occurring polymers with ferulic acid groups are sugar beet pectin and arabinoxylanes isolated from cereals.

Synthetic processes to prepare polymers with ferulic acid groups generally include esterification of ferulic acid to a free hydroxyl group situated on the polymer backbone or on a sugar substituent.

In a highly preferred embodiment, the ferulyolated polymer is a pectin, even more preferred sugar beet pectin. The principal building units of pectin are smooth homogalacturonic regions and rhamnified hairy regions in which most neutral sugars are located. Arabinose is the predominant neutral sugar. Galactose is present in rhamnogalacturonan. 50-55% of the ferulic acid groups are linked to arabinose units and about 45-50% of the ferulic acid groups are linked to galactose residues.

Preferably in the base composition at most 15 number %, more preferred at most 5% of the ferulic acid groups of the ferulyolated polymer are oxidized. Alternatively, in the polymer in the base composition, there are at least 20×10⁻⁴ mol g⁻¹ of unoxidised ferulic acid groups, more preferably at least 30×10⁻⁶ mol g⁻¹.

The base composition preferably comprises from 1 to 50 wt % of the ferulyolated polymer, more preferred from 1.5 to 20 wt %. It is preferred that the final product comprises from 1 to 3 wt % of the ferulyolated polymer.

The polymer preferably comprises from 0.1 to 4 wt % ferulic acid groups on total polymer weight, more preferred from 0.4 to 2 wt %.

The base composition comprises an inactivated oxidation system. Preferably this is an enzymatic oxidation system wherein the enzyme is selected from the group comprising peroxidase, oxygenase such as laccase, a polyphenol oxidase such as catechol oxidase, tyrosinase, or a combination thereof.

Peroxidases can be divided into those originating from plants, fungi or bacteria and those originating from a mammalian source such as myeloperoxidase and lactoperoxidase (LPO).

Laccases are obtainable from a variety of microbial sources notably bacteria and fungi (including filamentous fungi and yeasts), and suitable examples of laccases include those obtainable from strains of Aspergillus, Neurospora (e.g. N. crassa), Prodospora, Botrytis, Collybia, Fomes, Lentinus, Pleurotus, Trametes [some species/strains of which are known by various names and/or have previously been classified within other genera], Polyporus, Rhizoctonia, Coprinus, Psatyrella, Myceliophtora, Schytalidium, Phlebia or Coriolus.

Preferred enzymes are selected from the group comprising horseradish peroxidase, soy bean peroxidase, Arthromyces ramosus peroxidase and laccases that show a redox potential of preferably more than 400 mV and/or 550 mV as described in E. Solomon et al, Chem Rev, 1996, p 2563-2605.

The amount of enzyme added is expressed in terms of activity units corresponding to the activity shown after the enzyme has been converted to the active state (e.g. after addition of water or oxygen). Preferably enzyme is present in excess. The amount of enzyme added is preferably such that fast cross-linking occurs. For a peroxidase the amount of enzyme added is preferably from 10 to 100,000 units ABTS activity per ml of liquid end product.

Preferably the base composition comprises ingredients common to an aerated frozen confection. More preferred the base composition comprises fat, sweetener, protein, stabiliser, emulsifier, and optionally flavouring agents or colouring agents or a combination thereof.

The fat is preferably dairy fat or a vegetable fat or a combination thereof. The preferred vegetable fat is coconut oil. The amount of fat in the base composition is preferably from 0 to 50 wt %. The amount on final product after step (b) is preferably from 0 to 15 wt %.

Suitable sweeteners include but are not limited to sugars, sugar alcohols, corn syrup, starches. The preferred sweetener is sucrose. The amount of sweetener in the base composition is preferably from 5 to 90 wt %. The amount on final product after step (b) is preferably from 5 to 40 wt %.

Optionally the base composition comprises a stabiliser. The stabiliser is preferably selected from the group comprising locust bean gum, guar gum, carrageenan or a combination thereof. The amount of stabiliser in the base composition is preferably from 0 to 10 wt %. The amount on final product after step (b) is preferably from 0 to 2 wt %.

Optionally the base composition comprises an emulsifier. Suitable emulsifiers are for example monoglycerides of fatty acids, diglycerides of fatty acids, organic acid esters of monog lyce rides such as lactic, citric and acetic acids, or a combination thereof. The amount of emulsifier in the base composition is preferably from 0 to 10 wt %. The amount on final product after step (b) is preferably from 0 to 2 wt %.

The base composition must also comprise a protein. Although also other proteins may be included such as soy protein, the use of dairy protein is highly preferred because of their taste contribution. Preferred protein is derived from cream, skim milk (powder), milk (powder), butter milk (powder), or a combination thereof. The amount of protein in the base composition is preferably from 1 to 40 wt %. The amount on final product after step (b) is preferably from 0.6 to 6 wt %.

The base composition may be in any physical state. Because of ease of handling the viscous or powder form is preferred but also other states are encompassed in the invention. Preferably the base composition is a powder.

The base composition may be prepared in any suitable manner. According to one embodiment the base composition is prepared by mixing the ferulyolated polymer and optionally other ingredients at a temperature from 40 to 90° C. Optionally the product is then homogenised. The product is then cooled. The resulting mixture is degassed to remove oxygen. Optionally the mixture is bubbled with nitrous oxide to ensure it is essentially free of oxygen. The mixture is kept under anaerobic conditions. Subsequently a de-oxygenated enzyme solution comprising the oxidation system is added to the mixture whereby care is taken not to introduce oxygen or air. The resulting base composition is stored under anaerobic conditions.

The base composition is suitable for use in preparing aerated frozen confection products such as frozen ice cream, milk ice or water ice products. Ice cream, water ice and milk ice products are for example described in “Ice Cream” by R. T. Marshall & W. S. Arbuckle, 5^{th} edition 1996, Chapmann & Hall, New York.

In a further aspect the invention relates to a frozen aerated confection obtainable by the method according to the invention. Such confections show a surprisingly good stability against collapsing at temperatures of from − (minus) 40 to 60° C.

In another aspect the invention relates to an aerosol can comprising a base composition according to the invention and a propellant gas under pressure. It has surprisingly been found that when an aqueous base mix, propellant gas and a mixture of a ferulyolated polymer and an inactivated oxidising enzyme are combined in an aerosol can under conditions wherein oxidation does not yet take place, the product released from the can is stabilised by oxidized ferulyolated polymers.

By the term aerosol can is meant a packaging comprising a product and at least a propellant gas having an initial pressure of at least 3 barg and preferably from 5 to 10 barg at 20° C. The can is preferably provided with an opening. Such opening preferably is a valve enabling controlled dosage of the product.

The aerosol can is preferably prepared in a process comprising

a) introducing a viscous base composition without oxidation system into a container,

b) removing oxygen from said base composition

c) introducing in said container an inactivated oxidation system

d) charging the container with a gaseous propellant

e) chilling the container to a temperature below − (minus) 5° C.,

f) discharging the mix from the container to provide an aerated frozen confection product.

The resulting aerated confections are less prone to shrinkage or deformation upon storage than known products in the art, such as those disclosed in WO-A93/21777 which discloses a frozen gas-containing desert product having a thermal transition temperature in excess of −18° C. and a bulk density below 0.45 g/ml down to 0.09 g/ml to prevent or reduce unintended shrinkage and deformation.

The invention is illustrated by the following non limiting examples.

### EXAMPLES

General

Methods for Identification of Crosslink Reaction:

Method based on release of diferulic acid via hydrolysis of esterbonds by NaOH and analysis of diferulic acid by HPLC.

Method:

5 gram product (ice cream) was taken.

dilute sample 25×, in 0.1 N NaOH 19 hr (hydrolysation of esterbonds, diFA release)

neutralise sample with HCl, add 2% HAc/5% CH3CN

centrifuge 10 min in Eppendorf™ (14000 rpm, 15800 g)

filtrate supernatant resulting from centrifuge step through 0.22 μm filter prior to injection (20 μl) on HPLC

As a result of the alkali treatment ferulic acid was released from the feruloylated pectin and quantitative analysis of ferulic acid at 325 nm was done by external standard calibration of the ferulic acid peak in the pectin samples against pure ferulic acid references. A C18 ODS Hypersil column was used (3 μm 0.4×100 mm) with a Lichrospher 100 RP-18 guard column (5 μm 4×4 mm) from Hewlett Packard, USA. The following gradient was used for separation of different ferulic acid groups:

Solvents: A) 2% CH3CN/2% HAc/96% MilliQ water pH 2.8, B) 100% CH3CN; flow 1 ml/min

t=0′95% A, 5% B

t=10′ 70% A, 30% B

t=18′ 35% A, 65% B

t=20′ 0% A, 100% B

Stop time 25′; Post time 5′

The decrease of F-acid (retention time 7.2° cis and 7.5° trans) and the formation of the major diFacids components (retention times 8.5°, 9.2°, 11.3° and 11.5°) were analysed.

(Retention Times Vary With Each Column/Guard Column).

This method was based on the following reference:

Harukaza, A., Sugiyama, S., Iwamoto, Y. et al.; Convenient analysis and quantification of diferulic acids in foods; Food Science and Technology Res.; 2000, Vol. 6, no.2, p. 122-125.

### EXAMPLE 1

In this example, it is demonstrated that the use of the sugar beet pectin-oxidase system allows the creation of an ice cream mix that is liquid inside an aerosol can but which structures rapidly during foaming upon extrusion into an oxygen-containing atmosphere. As with conventional aerosol whipped creams, foaming is achieved by the effervescence of nitrous oxide upon decompression. The foam produced is extremely stable and therefore suitable for quiescent freezing to produce ice cream.

Base Mix Formulation

(Concentrations are w/w Unless Otherwise Stated)

2% Sugar beet pectin (Genu® Beta Pectin, CP Kelco).

20% Dextrose.

5% SMP.

5% Butterfat.

1% LACTEM L22 (lactic acid esters of mono-/di-glycerides, Danisco).

Water to 100%.

Procedure to Prepare the Base Mix (500 g)

Pectin, dextrose and SMP were dispersed in hot (60° C.) water using a Silverson™ mixer. The melted, liquid fat was then added, followed by the LACTEM™ and mixing continued for 5 minutes. The mix was then cooled at 20° C. for 2 hours.

Filling Procedure for the Aerosol

Clear, high-pressure 100 ml test glasses (Pamasol™) were used as the pressure vessels instead of aerosol cans to allow visualisation of the product under pressure. Two of these vessels were each filled with 60 g of the mix, filled with standard aerosol valves and degassed under vacuum. In order to ensure complete removal of O₂, the vessels were gassed to 9 bar with N₂O, shaken for 1 minute and then degassed. This gassing/shaking/degassing process was performed a total of 3 times.

Introduction of the Enzyme

To one of the vessels, 1 ml of an oxidase enzyme stock solution (Polyporus pinsitus laccase SP710 from Novo Nordisk; stock concentration=6.6 mg ml⁻′, 22 units/mg) was introduced through the valve using a syringe. Care was taken not to introduce any air with the enzyme solution.

Introduction of Gas

To both vessels, N₂O was added through the valve (taking care not to introduce air) at a pressure of 9 bar. The vessels were then removed from the gas supply and shaken vigorously for 10 seconds before being topped up by reconnecting to the 9 bar gas supply for a few seconds. Both vessels were left at 20° C. for 2 hours before testing.

Results

Visual inspection showed that the mix had remained liquid in both vessels during the 2 hour storage period (i.e. all of the mix flowed down the tube upon inverting it for 5 seconds). This implies that sufficient oxygen had been removed from the vessels to prevent cross-linking and gelation of the pectin.

Both mixes were then extruded into petri-dishes from the inverted vessels using an actuator designed for dispensing aerosol whipped creams. Extrusion from the vessel to which no enzyme had been added gave a foam structure that underwent rapid collapse. Conversely, extrusion from the vessel to which the enzyme had been added gave a very stable structure, implying that oxidative gelation of the pectin occurred very rapidly upon extrusion. The structure of the sample extruded from the vessel that contained enzyme was stable for the duration of the storage period (4 hours, 20° C.)

A further 50 ml portion was extruded into a tub from the vessel to which enzyme was added and immediately placed in a −25° C. cold store. Inspection of the resulting ice confection after 24 hours showed that the foam had frozen without visible collapse, shrinkage or separation.

### EXAMPLE 2

In this example, it is demonstrated that the use of a sugar beet pectin-peroxidase system allows the creation of a stable powdered ice cream mix that structures rapidly during simultaneous hydration and foaming. The enzyme system, (consisting of a peroxidase and glucose oxidase) is activated by hydration of the powder. Foaming is achieved by mechanical whipping. The foam produced is extremely stable and therefore suitable for freezing to produce ice cream.

Base Mix Formulations

(Concentrations are w/w)

Mix A (No Enzymes)

6.0% Sugar beet pectin (Genu® Beta Pectin, CP Kelco).

71.6% Sucrose.

12.0% Cream powder (36% fat cream powder from Dairy Crest Ingredients, contains 22.5% milk protein, 32.5% lactose, 6% ash and <3% moisture).

7.2% Skim milk powder

1.6% Hyfoama DS (Hydrolysed milk protein from Quest International).

1.6% Dextrose.

Mix B (+Enzymes)

Enzymes were added to Mix A to give:

0.8% Biobake Wheat (A peroxidase enzyme system from Quest International,

Activity is 2000 U/g)

0.04% Hyderase (A glucose oxidase from Amano).

From the material supplier's specifications, the mixes were calculated to contain approximately, 4% butter fat, 6% milk protein, 81% sugars (including lactose), 6% pectin and <3% moisture.

Procedure to Prepare the Base Mixes

The powdered ingredients of mix A were thoroughly mixed in a dry bowl with a spoon to ensure homogenous distribution of all components. This mix was then divided in half and the powdered enzymes added to one portion to form Mix B. Mix B was then thoroughly mixed in a dry bowl with a spoon to ensure homogenous distribution of the enzymes. Each dry mix was then sealed in a water-proof polythene bag and stored for 24 hours at 20° C.

Hydration and Aeration

The polythene bag containing the mix was opened and 125 g of mix immediately placed in the dry bowl of a Hobart mixer. To this, 375 g of cold tap water was added. The powder was then dispersed by gentle mixing (30 s at setting number 1) and then aerated, at 20° C., by whipping for 4 minutes on setting 2.

Characterisation of the Resulting Foams

Immediately following cessation of whipping, a cup of known volume was filled with foam and weighed. This was then repeated every 5 minutes for 15 minutes. The resulting densities were converted to overrun using the following relationship:

Overrun=

100*(Density of unaerated mix−Density of foam)/Density of foam.

Where the density of the unaerated mix was 1.1 g ml⁻¹.

In addition, a transparent plastic beaker was filled with foam immediately following cessation of whipping and inspected at 5-minute intervals for evidence of bubble creaming and serum separation.

Results

The foam created from mix A had an initial overrun of 84%. After 5 minutes, there was clear serum separation and creaming and after 10 minutes the overrun had decreased to 57%.

The foam created from mix B had an initial overrun of 95%. No creaming, serum separation or overrun loss was apparent even after 15 minutes. After 10 minutes, the pectin had clearly gelled as the container could be inverted without flow of the foam. In addition, quiescent freezing of a 50 ml portion of this foam (achieved by placing the portion in a store for 24 hours at −18° C., immediately following cessation of whipping) resulted in an ice confection with no visible collapse, shrinkage or separation.

Assessment of Enzyme Activity

The following procedure was used to assess the activity of the enzymatic oxidation system within the base mix and upon aeration:

After 24 hours storage at +20° C., 0.5 g of powdered mix B was taken. To this sample, 49.5 ml of 2 M NaOH was added and mixed on a magnetic stirrer. Mixing was continued at +20° C. for 2 hours before 7 ml of acetic acid were added. A 900 μl aliquot was then taken and mixed with 100 μl of a solution of 20% HAc/50% CH₃CN. The resulting dispersion was then centrifuged at 14,000 rpm for 15 minutes and the supernatant filtered through a 0.22 μm membrane filter. 20 μl was then injected for HPLC separation (as described in the Methods section) and the total area of the ferulic acid peaks (i.e. monomeric cis- and trans-ferulic acid) measured. This peak area is designated A₀.

In order to assess the activity of the enzymatic oxidation system within the base mix, 0.5 g of mix B was taken after storage at +20° C. for 8 days. To this sample, 49.5 ml of 2 M NaOH was added and mixed on a magnetic stirrer. Mixing was continued at +20° C. for 2 hours before 7 ml of acetic acid were added. A 900 μl aliquot was then taken and mixed with 100 μl of a solution of 20% HAc/50% CH₃CN. The resulting dispersion was then centrifuged at 14,000 rpm for 15 minutes and the supernatant filtered through a 0.22 μm membrane filter. 20 μl was then injected for HPLC separation and the total area of the monomeric ferulic acid peaks measured. The peak area for this sample was designated A₇. The percentage change in the peak area (i.e. 100*[A₀-A₇]/A₀) was taken as the number % of ferulic acid residues on the polymer that are converted to di-ferulic acid residues after storage for 1 week. This number was 3.7%, clearly indicating that the enzymatic oxidation system was essentially inactivated in the base mix.

In order to assess the activity of the enzymatic oxidation system upon hydration and aeration, 100 g of mix B was mixed with 300 ml tapwater and whipped as described above. 15 minutes after the addition of tapwater, 2 g of the foam was diluted with 48 ml of 2 M NaOH. Mixing was continued at +20° C. for 2 hours before 7 ml of acetic acid were added. A 900 μl aliquot was then taken and mixed with 100 μl of a solution of 20% HAc/50% CH₃CN. The resulting dispersion was then centrifuged at 14,000 rpm for 15 minutes and the supernatant filtered through a 0.22 μm membrane filter. 20 μl was then injected for HPLC separation and the total area of the monomeric ferulic acid peaks measured. The peak area for this sample was designated A₁₅. The percentage change in the peak area (i.e. 100*[A₀-A₁₅]/A₀) was taken as the number % of ferulic acid residues on the polymer that are converted to di-ferulic acid residues within 15 minutes. This number was 56%, clearly indicating that the enzymatic oxidation system was activated upon hydration and whipping.

### EXAMPLE 3

The following recipe of home made ice cream was used:

Formulation in terms of wt % on final product weight with number of grams used and supplier name in brackets.

5% egg white powder (10 g, van Enthoven, the Netherlands)

3% whey powder (6 g Lacprodan-80 Aria Food products, Denmark)

18% sucrose powder (36 g CSM, the Netherlands)

0.1% glucose (or 0.05%) (0.2 g Sigma, USA)

2% sugar beet pectin (4 g CP Kelco, Denmark)

0.2% Biobake wheat comprising soy bean peroxidase (food grade, Quest the Netherlands)

0.005% glucose oxidase (0.01 g Hydrase, from Amano, Japan)

150 ml water or milk was added to come to a final product volume of 200 ml followed by mixing 3 till 5 minutes using a normal kitchen mixer or a Hobart mixer, followed by freezing the ice mix in a domestic deep-freeze (−20° C.).

The resulting product was stable and did not collapse upon storage.

Assessment of Enzyme Activity

The following procedure was used to assess the activity of the enzymatic oxidation system within the base mix and upon aeration:

After 24 hours storage at +20° C., 0.5 g of powdered mix was taken. To this sample, 49.5 ml of 2 M NaOH was added and mixed on a magnetic stirrer. Mixing was continued at +20° C. for 2 hours before 7 ml of acetic acid were added. A 900 μl aliquot was then taken and mixed with 100 μl of a solution of 20% HAc/50% CH₃CN. The resulting dispersion was then centrifuged at 14,000 rpm for 15 minutes and the supernatant filtered through a 0.22 μm membrane filter. 20 μl was then injected for HPLC separation and the area of the monomeric ferulic acid peaks measured. This peak area is designated A₀.

In order to assess the activity of the enzymatic oxidation system within the base mix, 0.5 g of the mix was taken after storage at +20° C. for 8 days. To this sample, 49.5 ml of 2 M NaOH was added and mixed on a magnetic stirrer. Mixing was continued at +20° C. for 2 hours before 7 ml of acetic acid were added. A 900 μl aliquot was then taken and mixed with 100 μl of a solution of 20% HAc/50% CH₃CN. The resulting dispersion was then centrifuged at 14,000 rpm for 15 minutes and the supernatant filtered through a 0.22 μm membrane filter. 20 μl was then injected for HPLC separation and the area of the monomeric ferulic acid peaks measured. The peak area for this sample was designated A₇. The percentage change in the peak area (i.e. 100*[A₀-A7]/A⁰) was taken as the number % of ferulic acid residues on the polymer that are converted to di-ferulic acid residues after storage for 1 week. This number was 4.3%, clearly indicating that the enzymatic oxidation system was essentially inactivated in the base mix.

In order to assess the activity of the enzymatic oxidation system upon hydration and aeration, 100 g of the mix was mixed with 300 ml tapwater and whipped as described above. 15 minutes after the addition of tapwater, 2 g of the foam was diluted with 48 ml of 2 M NaOH. Mixing was continued at +20° C. for 2 hours before 7 ml of acetic acid were added. A 900 μl aliquot was then taken and mixed with 100 μl of a solution of 20% HAc/50% CH₃CN. The resulting dispersion was then centrifuged at 14,000 rpm for 15 minutes and the supernatant filtered through a 0.22 μm membrane filter. 20 μl was then injected for HPLC separation and the area of the monomeric ferulic acid peaks measured. The peak area for this sample was designated A₁₅. The percentage change in the peak area (i.e. 100*[A₀-A₁₅]/A₀) was taken as the number % of ferulic acid residues on the polymer that are converted to di-ferulic acid residues within 15 minutes. This number was 16%, clearly indicating that the enzymatic oxidation system was activated upon hydration and whipping.

### EXAMPLE 4

In this example, it is demonstrated that the use of the sugar beet pectin-oxidase system allows the creation of an ice cream mix that is liquid inside an aerosol can but which structures rapidly during foaming upon extrusion into an oxygen-containing atmosphere. It is also demonstrated that this extrusion can occur at frozen temperatures (e.g. −10° C.).

Base Mix Formulation

(Concentrations are w/w Unless Otherwise Stated)

2% Sugar beet pectin (Genu® Beta Pectin, CP Kelco).

20% Dextrose.

5% SMP.

5% Butterfat.

1% ACETEM (Acetic acid esters of mono-/di-glycerides, Danisco).

Water to 100%.

Procedure to Prepare the Base Mix (3000 g)

Pectin, dextrose and SMP were dispersed in hot (60° C.) water using a Silverson™ mixer. The liquid fat and ACETEM™ were melted together and the resulting liquid added to the other ingredients. Mixing was continued for a further 15 minutes to homogenize the mix. The mix was then pasteurized by heating rapidly to 90° C. on an agitated steam kettle and then crash cooled to +2° C. by surrounding the mix container with iced water.

Filling Procedure for the Aerosol

Aluminum aerosol cans with a brim-fill capacity of 325 ml (Cebal™) were used as the pressure vessels. These vessels were filled with 180 g of the mix, fitted with standard aerosol valves (as used for whipped cream, supplied by Precision Valve UK Ltd) and degassed under vacuum. In order to ensure complete removal of O₂, the vessels were gassed to 9 bar with N₂O, shaken for 1 minute and then degassed. This gassing/shaking/degassing process was performed a total of 3 times.

Introduction of the Enzyme

To each vessel 3 ml of an oxidase enzyme stock solution (Polyporus pinsitus laccase SP710 from Novo Nordisk; stock concentration=6.6 mg ml⁻¹, 22 units/mg) was introduced through the valve using a syringe. Care was taken not to introduce any air with the enzyme solution.

Introduction of Gas

To each vessel, N₂O was added through the valve (taking care not to introduce air) at a pressure of 9 bar. The vessels were then removed from the gas supply and shaken vigorously for 10 seconds before being topped up by reconnecting to the 9 bar gas supply for a few seconds. The vessels were stored at +2° C.

Results

The ability of the mix to remain fluid inside the vessels and create a stable foam on extrusion was tested by dispensing 50 ml portions of foam after 9 days and 3 weeks storage at +2° C. The mix remained fluid enough over the whole 3 week storage period to allow dispensing and there was no noticeable deterioration in the dispensing rate. In addition, all of the extruded foams had a structure that was stable for at least 5 hours at +20° C.

One of the vessels was placed at −10° C. for 7 hours. It was found that the resulting frozen mix could be extruded from the can to give a frozen confection with a texture intermediate between a soft ice cream and a mousse. In addition, the confection retained its shape for at least 1 hour at +20° C.

Assessment of Enzyme Activity

The following procedure was used to assess the activity of the enzymatic oxidation system within the container and upon dispensing:

A vessel was removed from the +2° C. store after 2 days and 5 g of foam dispensed into a 250 ml glass beaker. To this sample, 120 ml of 0.1 M NaOH was added immediately (less than 5 s) and mixed on a magnetic stirrer. Mixing was continued at +20° C. for 19 hours. The resulting dispersion was then centrifuged at 14,000 rpm for 15 minutes and the supernatant filtered through a 0.22 μm membrane filter. 20 μl was then injected for HPLC separation and the area of the monomeric ferulic acid peaks measured. This peak area is designated A₀.

In order to assess the activity of the enzymatic oxidation system within the container, the same vessel was removed from the +2° C. store after a further 7 days storage and 5 g of foam dispensed into a 250 ml glass beaker. To this sample, 120 ml of 0.1 M NaOH was added immediately (less than 5 s) and mixed on a magnetic stirrer. Mixing was continued at +20° C. for 19 hours. The resulting dispersion was then centrifuged at 14,000 rpm for 15 minutes and the supernatant filtered through a 0.22 μm membrane filter. 20 μl was then injected for HPLC separation and the area of the monomeric ferulic acid peaks measured. The peak area for this sample was designated A₇. The percentage change in the peak area (i.e. 100*[A₀-A₇]/A₀) was taken as the number % of ferulic acid residues on the polymer that are converted to di-ferulic acid residues after storage for 1 week. This number was 10%, indicating that the enzymatic oxidation system was not totally inactivated in the container, probably owing to the failure to exclude oxygen whilst preparing the sample.

In order to assess the activity of the enzymatic oxidation system upon dispensing, the same vessel was removed from the +2° C. store after a total of 2 days storage and 5 g of foam dispensed into a 250 ml glass beaker. This foam was then stored at +20° C. for 15 minutes. 120 ml of 0.1 M NaOH was then added immediately and mixed on a magnetic stirrer. Mixing was continued at +20° C. for 19 hours. The resulting dispersion was then centrifuged at 14,000 rpm for 15 minutes and the supernatant filtered through a 0.22 μm membrane filter. 20 μl was then injected for HPLC separation and the area of the monomeric ferulic acid peaks measured. The peak area for this sample was designated A₁₅. The percentage change in the peak area (i.e. 100*[A₀-A₁₅]/A₀) was taken as the number % of ferulic acid residues on the polymer that are converted to di-ferulic acid residues within 15 minutes. This number was 57%, clearly indicating that the enzymatic oxidation system was activated upon dispensing.

In order to assess the activity of the enzymatic oxidation system upon dispensing at frozen temperatures, a vessel was placed at −10° C. for 6 hours. This was then removed from the −10° C. store and two 5 g portions of foam dispensed into separate 250 ml glass beakers. To one of the foams, 120 ml of 0.1 M NaOH was added immediately. The other was stored at +20° C. for 15 minutes before addition of 120 ml of 0.1 M NaOH. Both samples were then agitated on a magnetic stirrer for +20° C. for 19 hours prior to centrifugation at 14,000 rpm for 15 minutes. The supernatants were then filtered through a 0.22 μm membrane filter before 20 μl of each was injected for HPLC separation. The total monomeric ferulic acid peak area for the sample to which NaOH was added immediately was designated B₀ and that for the sample aged for 15 minutes was designated B₁₅. The percentage change in the peak area (i.e. 100*[B₀-B₁₅]/B₀) was taken as the number % of ferulic acid residues on the polymer that are converted to di-ferulic acid residues within 15 minutes. This number was 65%, clearly indicating that the enzymatic oxidation system was activated upon dispensing.

### EXAMPLE 5

The procedure described in examples 1 and 4 for making an aerosol container essentially free from oxygen relies upon great care being taken to exclude air during the many stages involved. As a result the procedure is not very robust (as demonstrated by the failure to completely deactivate the enzyme system in example 4). It has been found that the procedure can be made more robust by inclusion of ascorbic acid in the base mix in order to scavenge any residual oxygen in the container. This example demonstrates such a mix.

Base Mix Formulation

(Concentrations are w/w Unless Otherwise Stated)

2% Sugar beet pectin (Genu® Beta Pectin, CP Kelco).

20% Dextrose.

5% SMP.

5% Butterfat.

1% ACETEM (Acetic acid esters of mono-/di-glycerides, Danisco).

0.05% Ascorbic Acid

Water to 100%.

Procedure to Prepare the Base Mix (1000 g)

Pectin, dextrose and SMP were dispersed in hot (60° C.) water using a Silverson™ mixer. The liquid fat and ACETEM™ were melted together and the resulting liquid added to the other ingredients. Mixing was continued for a further 15 minutes to homogenize the mix. The mix was then pasteurized by heating rapidly to 90° C. on an agitated steam kettle and then crash cooled to +2° C. by surrounding the mix container with iced water. Ascorbic acid was then added and dissolved by gentle agitation.

Filling Procedure for the Aerosol

Aluminum aerosol cans with a brim-fill capacity of 325 ml (Cebal™) were used as the pressure vessels. These vessels were filled with 180 g of the mix, fitted with standard aerosol valves (as used for whipped cream, supplied by Precision Valve UK Ltd) and degassed under vacuum. In order to ensure complete removal of O₂, the vessels were gassed to 9 bar with N₂O, shaken for 1 minute and then degassed. This gassing/shaking/degassing process was performed a total of 3 times.

Introduction of the Enzyme

To each vessel 3 ml of an oxidase enzyme stock solution (Polyporus pinsitus laccase SP710 from Novo Nordisk; stock concentration=6.6 mg ml⁻′, 22 units/mg) was introduced through the valve using a syringe. Care was taken not to introduce any air with the enzyme solution.

Introduction of Gas

To each vessel, N₂O was added through the valve (taking care not to introduce air) at a pressure of 9 bar. The vessels were then removed from the gas supply and shaken vigorously for 10 seconds before being topped up by reconnecting to the 9 bar gas supply for a few seconds. The vessels were stored at +2° C.

Results

The ability of the mix to remain fluid inside the vessels and create a stable foam on extrusion was tested by dispensing 50 ml portions of foam after 9 days and 3 weeks storage at +2° C. The mix remained fluid enough over the whole 3 week storage period to allow dispensing and there was no noticeable deterioration in the dispensing rate. The extruded foams held their volume for at least 4 hours at +20° C. but did show some flow and loss of shape. This indicates that the ascorbic acid inhibited the cross-linking of the pectin such that a less stable foam than that described in example 4 was produced. It is envisaged that the level of ascorbic acid used could be optimised depending on the foam stability required and the robustness of the manufacturing process in terms of excluding oxygen.

Assessment of Enzyme Activity

The following procedure was used to assess the activity of the enzymatic oxidation system within the container and upon dispensing:

A vessel was removed from the +2° C. store after 2 days and 5 g of foam dispensed into a 250 ml glass beaker. To this sample, 120 ml of 0.1 M NaOH was added immediately (less than 5 s) and mixed on a magnetic stirrer. Mixing was continued at +20° C. for 19 hours. The resulting dispersion was then centrifuged at 14,000 rpm for 15 minutes and the supernatant filtered through a 0.22 μm membrane filter. 20 μl was then injected for HPLC separation and the area of the monomeric ferulic acid peaks measured. This peak area is designated A₀.

In order to assess the activity of the enzymatic oxidation system within the container, the same vessel was removed from the +2° C. store after a further 7 days storage and 5 g of foam dispensed into a 250 ml glass beaker. To this sample, 120 ml of 0.1 M NaOH was added immediately (less than 5 s) and mixed on a magnetic stirrer. Mixing was continued at +20° C. for 19 hours. The resulting dispersion was then centrifuged at 14,000 rpm for 15 minutes and the supernatant filtered through a 0.22 μm membrane filter. 20 μl was then injected for HPLC separation and the area of the monomeric ferulic acid peaks measured. The peak area for this sample was designated A₇. The percentage change in the peak area (i.e. 100*[A₀-A₇]/A₀) was taken as the number % of ferulic acid residues on the polymer that are converted to di-ferulic acid residues after storage for 1 week. This number was 1.8%, clearly indicating that the enzymatic oxidation system was essentially inactivated in the container.

In order to assess the activity of the enzymatic oxidation system upon dispensing, the same vessel was removed from the +2° C. store after a total of 2 days storage and 5 g of foam dispensed into a 250 ml glass beaker. This foam was then stored at +20° C. for 15 minutes. 120 ml of 0.1 M NaOH was then added immediately and mixed on a magnetic stirrer. Mixing was continued at +20° C. for 19 hours. The resulting dispersion was then centrifuged at 14,000 rpm for 15 minutes and the supernatant filtered through a 0.22 μm membrane filter. 20 μl was then injected for HPLC separation and the area of the monomeric ferulic acid peaks measured. The peak area for this sample was designated A₁₅. The percentage change in the peak area (i.e. 100*[A₀-A₁₅]/A₀) was taken as the number % of ferulic acid residues on the polymer that are converted to di-ferulic acid residues within 15 minutes. This number was 12%, indicating that the enzymatic oxidation system was not very well activated upon dispensing and that the ascorbic acid inhibited the cross-linking reaction. It is envisaged that the level of ascorbic acid used could be optimised depending on the foam stability required and the robustness of the manufacturing process in terms of excluding oxygen.

1. A method for the preparation of an aerated frozen confection which comprises the steps of:—
a base composition comprising a ferulyolated polymer and an essentially inactivated enzymatic oxidation system is packed into a container under conditions wherein the enzymatic oxidation system remains essentially inactivated;
b) at least a portion of the base composition is combined with a substance that activates the enzymatic oxidation system;
c) aeration; and
d) the base composition and/or the composition resulting from step (b) or step (c) is subjected to freezing conditions;
wherein aeration is simultaneous with activation of the oxidation system in step (b).

2. The method of claim 1, wherein the container of step (a) is transported to a remote location before step (b) takes place.

3. The method of claim 1, wherein the container is disposable.

4. The method of claim 1, wherein the container has a size of one serving and in step (b) the entire contents of the container are combined with a substance that activates the enzymatic oxidation system.

5. The method of claim 1, wherein the substance that activates the enzymatic oxidation system is selected from the group comprising oxygen and water or a combination thereof.

6. The method of claim 1, wherein the ferulyolated polymer is a pectin.

7. The method of claim 1, wherein in the base composition at most 15 number % of the ferulic acid groups of the ferulyolated polymer are oxidized.

8. The method of claim 1, wherein the enzymatic oxidation system is an enzyme selected from the group comprising peroxidase, a polyphenol oxidase such as catechol oxidase, tyrosinase, or a laccase or a combination thereof.

9. The method of claim 1, wherein the base composition further comprises fat, sweetener, protein, stabiliser, emulsifier, and optionally flavouring agents or colouring agents or a combination thereof.

10. The method of claim 1, wherein the base composition is a powder.

11. A base composition for a frozen aerated confection, said composition comprising a ferulyolated polymer and an essentially inactivated enzymatic oxidation system and a protein, preferably a dairy protein.

12. The composition of claim 11, wherein the total amount of protein in the composition is from 1% to 40% by weight.

13. The composition of claim 11, wherein the ferulyolated polymer is a pectin.

14. The composition of claim 11, wherein in the base composition at most 15 number % of the ferulic acid groups of the ferulyolated polymer are oxidized.

15. The composition of claim 11, wherein the enzymatic oxidation system is an enzyme selected from the group comprising peroxidase, a polyphenol oxidase such as catechol oxidase, tyrosinase, or a laccase or a combination thereof.

16. The composition of claim 11, wherein the base composition further comprises fat, sweetener, protein, stabiliser, emulsifier, and optionally flavouring agents or colouring agents or a combination thereof.

17. The composition of claim 11, wherein the base composition is a powder.

18. The composition of claim 11, further comprising any of ascorbic acid, and organic and inorganic (eg an alkali metal such as sodium) salts thereof, and mixtures thereof.

19. An aerosol can comprising a base composition for a frozen aerated confection, said composition comprising a ferulyolated polymer and an essentially inactivated enzymatic oxidation system and a protein, preferably a dairy protein; and a propellant gas under pressure.
